(19) United States
(12) Patent Application Publication
(10) Pub. No.: US 2007/0265890 A1
(43) Pub. Date: Nov. 15, 2007

(54) INTERACTIVE ELECTRONIC BOARDING DISPLAY

(76) Inventor: Vicki A. Curtis, Stanwood, WA (US)

Correspondence Address: INGRASSIA FISHER & LORENZ, P.C. (BOEING), 7150 E. CAMELBACK RD., SUITE 325, SCOTTSDALE, AZ, 85251, US

(21) Appl. No.: 11/383,001

(22) Filed: May 12, 2006

(51) Int. Cl. G06Q 10/00

(52) U.S. Cl. 705/5

(57) ABSTRACT

A system and technique for generating an interactive and dynamic seating layout with passenger boarding information is disclosed. The system includes an electronic display element controlled to display a seating layout that accurately depicts the configuration of seats on a vehicle to be boarded. During the boarding procedure, the seating layout is updated in real-time with distinguishing visual elements that indicate whether seats are awaiting boarding, currently boarding, or have already boarded.

### TECHNICAL FIELD

Embodiments of the present invention relate generally to information display systems. More particularly, embodiments of the present invention relate to an electronic boarding display for transportation systems.

### BACKGROUND

Millions of people travel by aircraft every day. Aircraft boarding procedures regulate the manner in which passengers board departing aircraft. For example, some airlines utilize an open seating system where passengers board the aircraft in a number of groups without having reserved seating assignments. Most airlines, however, maintain the traditional seating system where each passenger has a reserved seating assignment, typically identified by a row number and a seat position identifier for that row (such as a letter). It is well established that efficient boarding procedures alleviate passenger stress, reduce passenger confusion, and reduce flight crew confusion. Moreover, quicker aircraft boarding procedures result in less ground time, which can translate into increased profitability for airlines.

In connection with most boarding procedures, the ground crew announces over a public address system which section of the aircraft is to board next. Quite often the passenger gate area is noisy, speaker quality is poor, and waiting passengers are inattentive. Consequently, passengers waiting to board have a difficult time identifying who is to board next. If a passenger misses the audio announcement, they may end up boarding late or out of sequence, thus hindering the boarding process. Furthermore, audible boarding announcements are usually restricted to the immediate passenger gate area and passengers in other areas of the airport typically have no access to the current boarding status. Moreover, international travelers experience difficulty in the boarding process when they are not fluent in the language spoken by airline staff during audio boarding announcements. A similar difficulty is experienced by passengers who are hearing impaired.

Studies in different approaches to boarding indicate that boarding by smaller sections is more efficient than boarding by larger sections or random boarding. Boarding in smaller sections, however, tends to be difficult for the ground crew to announce and control, and is often confusing to passengers waiting to board. Therefore, airlines are interested in other methods of boarding to reduce turn time and improve passenger satisfaction.

### BRIEF SUMMARY

A passenger boarding system as described herein employs an interactive boarding display that allows airlines to board in smaller sections while eliminating passenger confusion. The passenger boarding display enhances conventional methods that rely on audible call-offs of boarding rows. In one embodiment, the system also provides the passenger information regarding how long of a delay before their section boards.

The above and other aspects of the invention may be carried out in one embodiment by a passenger boarding display comprising an electronic display element controlled to display a seating layout for a vehicle, the seating layout having predetermined characteristics that are representative of an actual seating configuration for the vehicle, and the seating layout having dynamic characteristics that are representative of real-time passenger boarding information.

The above and other aspects of the invention may be carried out in one embodiment by a system for displaying passenger boarding instructions for a vehicle. The system includes: a database containing electronic seating layouts corresponding to actual seating configurations for a number of different vehicles; a processing architecture coupled to the database, the processing architecture being configured to select an electronic seating layout for a designated vehicle; and an electronic display element coupled to the processing architecture, the electronic display element being configured to display a current seating layout for the designated vehicle, the current seating layout having predetermined characteristics that are representative of an actual seating configuration for the vehicle, and the current seating layout having dynamic characteristics that are representative of real-time passenger boarding information.

The above and other aspects of the invention may be carried out in another embodiment by a system for displaying passenger boarding instructions for a vehicle. The system includes: a database containing electronic seating layouts corresponding to actual seating configurations for a number of different vehicles; a processing architecture coupled to the database, the processing architecture being configured to select an electronic seating layout for a designated vehicle; and an electronic display element coupled to the processing architecture, the electronic display element being configured to display a current seating layout for the designated vehicle, the current seating layout having predetermined characteristics that are representative of an actual seating configuration for the vehicle, and the current seating layout having dynamic characteristics that are representative of real-time passenger boarding information.

The above and other aspects of the invention may be carried out in another embodiment by a method of displaying passenger boarding instructions for a vehicle. The method involves: accessing an electronic seating layout corresponding to an actual seating configuration for the vehicle; obtaining real-time passenger boarding information for the vehicle; and displaying a current seating layout on a passenger display element, the current seating layout having predetermined characteristics that are representative of the actual seating configuration for the vehicle, and the current seating layout having dynamic characteristics that are representative of the real-time passenger boarding information.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a diagram of an airport passenger gate area configured in accordance with an embodiment of the invention;

FIG. 2 is a diagram of a passenger gate monitor configured in accordance with an embodiment of the invention;

FIG. 3 is a diagram of a seating layout generated by a passenger boarding display configured in accordance with an embodiment of the invention;

FIG. 4 is a schematic representation of a system for displaying passenger boarding instructions; and

FIG. 5 is a flow chart of an example boarding display control process.

### DETAILED DESCRIPTION

The following detailed description is merely illustrative in nature and is not intended to limit the embodiments of the invention or the application and uses of such embodiments. Furthermore, there is no intention to be bound by any expressed or implied theory presented in the preceding technical field, background, brief summary or the following detailed description.

Embodiments of the invention may be described herein in terms of functional and/or logical block components and various processing tasks, routines, techniques, steps, or methodologies. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present invention may be practiced in conjunction with any number of transportation systems and that the airport deployment described herein is merely one embodiment of the invention.

For the sake of brevity, conventional techniques related to network data communication, electronic display control, graphics generation, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention.

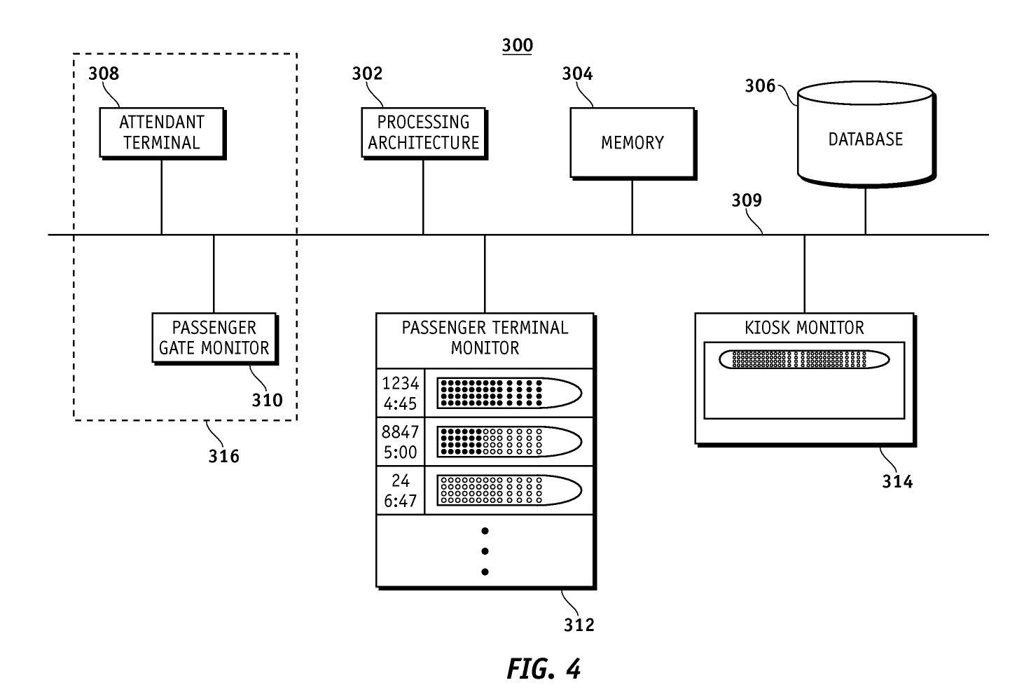

The following description refers to elements or nodes or features being “connected” or “coupled” together. As used herein, unless expressly stated otherwise, “connected” means that one element/node/feature is directly joined to (or directly communicates with) another element/node/feature, and not necessarily mechanically. Likewise, unless expressly stated otherwise, “coupled” means that one element/node/feature is directly or indirectly joined to (or directly or indirectly communicates with) another element/node/feature, and not necessarily mechanically. Thus, although the schematic shown in FIG. 4 depicts one example arrangement of elements, additional or fewer elements, devices, features, or components may be present in an embodiment of the invention.

The following description of embodiments focuses on an airport deployment where passengers are boarding onto an aircraft. The general concepts of the invention, however, can apply to other transportation systems, vehicles, or attractions, and the aircraft implementation described herein is not intended to restrict or otherwise limit the scope or application of embodiments of the invention. For example, the system and technique described herein may be utilized in connection with passenger boarding for any of the following vehicles or attractions, without limitation: trains; buses; cruise ships; thrill rides; concert venues; theaters; subways; or the like.

An embodiment of the invention utilizes an interactive boarding display that is suitably controlled to allow airlines to board aircraft in smaller sections while eliminating passenger confusion. In one practical deployment, the boarding display provides secondary visual information that augments audible boarding calls. As described in more detail below, the display includes a seating layout of the aircraft being boarded. Sections that are currently boarding could be visually identified in a distinguishable manner to allow passengers to easily see which section is currently boarding. The areas that have already boarded could be displayed using a different scheme, and areas that are awaiting boarding could be displayed using yet another scheme (for example, they may be left blank or unlit). The boarding display is controlled by a software application that enables the display to be updated in real-time such that passengers can easily determine if their section is actively boarding, if their section is next to board, or if their section has already boarded.

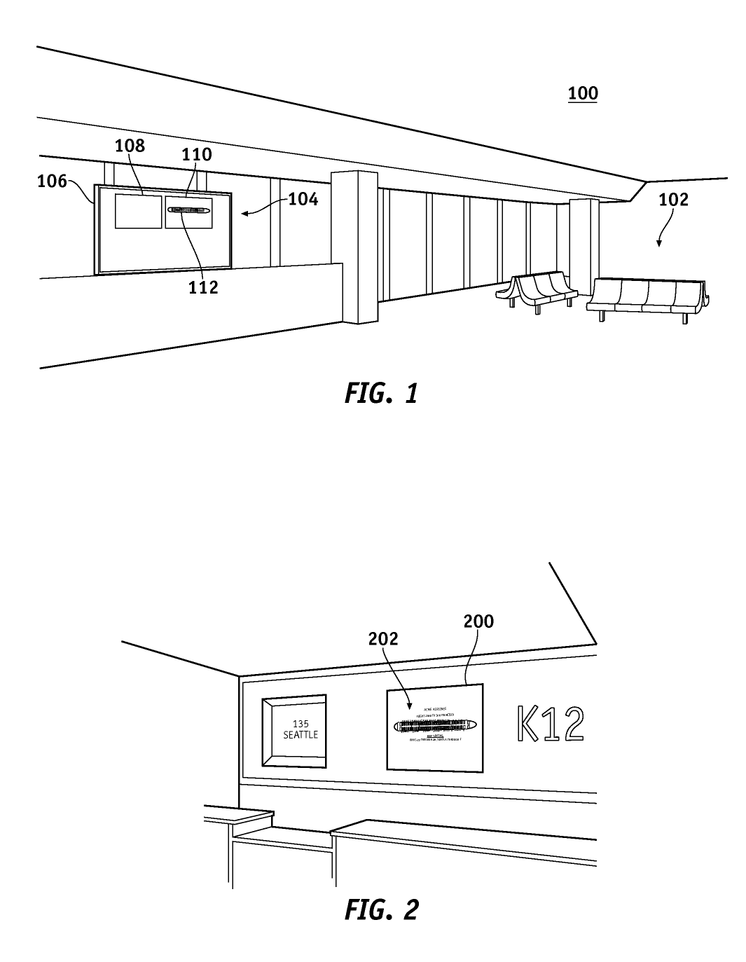

FIG. 1 is a diagram of an airport passenger gate area 100, which represents one example environment in which an embodiment of the invention can be deployed. Gate area 100 includes features that are typically found in most airports, such as a passenger waiting area 102, an airline attendant station 104, and a passenger gate information board 106, which may include one or more passenger gate monitors 108/110. As departure time approaches, passenger gate area 100 may become full of passengers waiting to board their aircraft, and passenger gate area 100 may become loud, noisy, and hectic.

Passenger gate information board 106 may be utilized to convey flight information to the passengers, including, without limitation: the flight number (for arriving and/or departing flights); the arrival time for arriving flights; the departure time for departing flights; the arrival or departure status (e.g., whether a flight is on-time, delayed, or canceled); the name of the airline; and/or the current time. In this example, some or all of this information may be electronically displayed on passenger gate monitor 108. An embodiment of the invention may utilize passenger gate monitor 110 (or passenger gate monitor 108 if necessary) as a passenger boarding display that is controlled to display a seating layout 112 for a departing aircraft. If passenger gate information board 106 includes only one monitor or display element, then seating layout 112 may be displayed in a periodic or alternating manner with the other flight information. In an alternate deployment, seating layout 112 may be generated on a passenger gate monitor located anywhere within passenger gate area 100 and/or anywhere throughout the airport, and seating layout 112 need not be located behind a counter as shown in FIG. 1. Moreover, if coupled to an appropriately configured network, seating layout 112 may even be generated on a monitor located outside of the airport environment, e.g., in a hotel, a restaurant, on any computing device having access to the Internet, in a vehicle, or the like.

FIG. 2 is a diagram of a passenger gate monitor 200 configured in accordance with an embodiment of the invention. FIG. 2 depicts how an otherwise conventional or existing electronic display element can be utilized to generate a seating layout 202 for a departing aircraft. In one embodiment of the invention, passenger gate monitor 200 is a flat panel LCD or plasma display that is coupled to a suitable computing device or computing system having the desired processing logic and application software. In practice, passenger gate monitor 200 could replace existing static displays that only display the airline and flight number. As depicted in FIG. 2, passenger gate monitor 200 is preferably sized such that seating layout 202 can be easily viewed and interpreted from practical distances.

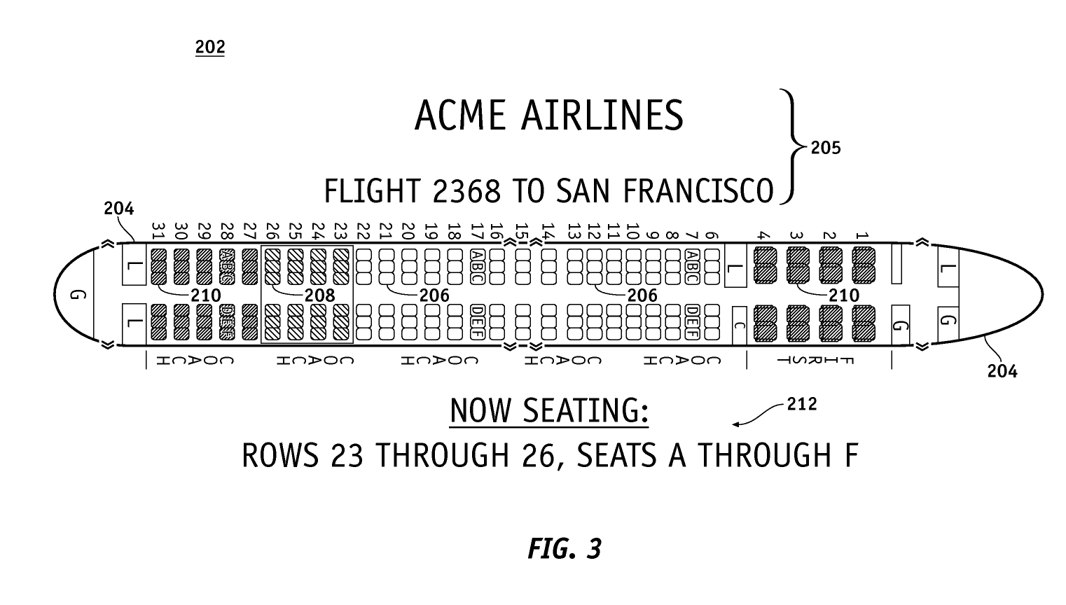

FIG. 3 is a diagram of seating layout 202, which may be generated by a passenger boarding display configured in accordance with an embodiment of the invention. Seating layout 202 represents the actual seating configuration of the particular aircraft. In other words, seating layout 202 accurately reflects the number of seats, the rows of seats, and the different classes of seats. In practice, therefore, each aircraft may have a respective seating layout that can be displayed at departure time. In operation, seating layout 202 may be interactively and dynamically displayed, and seating layout 202 may be updated in real-time according to the current boarding status of the departing aircraft. Thus, the current version of seating layout 202 will change to reflect the current status of the passenger boarding procedure. Accordingly, FIG. 3 merely represents a snapshot in time for seating layout 202.

Seating layout 202 may be constructed from an electronic layout template that generally represents the configuration of seats for the aircraft. A predetermined layout template may be produced by the aircraft manufacturer for use by the airline after deployment of the aircraft. For example, such layout templates may be utilized or customized for purposes of ticketing, customer seat selection, or the like. In this regard, a system as described herein can leverage such layout templates and modify the template files as needed for purposes of the boarding status displays described herein.

Seating layout 202 generally includes predetermined characteristics that are representative of the actual seating configuration for the departing aircraft, and dynamic characteristics that are representative of real-time passenger boarding information. As used herein, “predetermined characteristics” are display elements or features that need not change over time. Such predetermined characteristics are not influenced by the current passenger boarding status, and such predetermined characteristics need not be updated during the passenger boarding procedure. As used herein, “dynamic characteristics” are display elements or features that can change over time. Such dynamic characteristics can be influenced by the current passenger boarding status, by a desired passenger boarding sequence, by a programmed boarding sequence (described in more detail below), or the like. The dynamic characteristics can be updated during the passenger boarding procedure to convey the current boarding instructions and/or the current boarding status to the waiting passengers. In practice, a particular seating layout may utilize only dynamic characteristics, only predetermined characteristics, or a combination thereof.

In this example, seating layout 202 includes the following (and possibly other) predetermined characteristics: an outline 204 of the departing aircraft; a top view of seats on the departing aircraft; seat position identifiers for seats on the departing aircraft; row designations for seats on the departing aircraft; and class designations for seats on the departing aircraft. Outline 204 may be desirable to enable viewers to quickly identify the different seating sections relative to the fore/aft orientation of the aircraft. The seat position identifiers may be letters (A, B, C, D, E, and F in this example), numbers, characters, or any distinguishable marking. The row designations may be numbers (1-4 and 6-31 in this example), letters, characters, or any distinguishable marking, where each seat on the aircraft is uniquely identified by its row designation and seat position identifier. The class designations may be text, characters, or any distinguishable indicia that differentiates the different class groups for the seats. In this example, seating layout 202 includes a “First Class” designation for rows 1-4, and “Coach Class” designations for the remaining rows. The display element for seating layout 202 may also be controlled to display flight information 205 that typically remains static during passenger boarding. Such flight information 205 may include the name of the airline, the flight number, the destination city, and the like.

In this example, seating layout 202 includes the following (and possibly other) dynamic characteristics: first indicia 206 corresponding to seats on the vehicle that are awaiting passenger boarding; second indicia 208 corresponding to seats on the vehicle for which passengers are currently boarding; and third indicia 210 corresponding to seats on the vehicle that have already been boarded by passengers. The first, second, and third indicia may be any visibly distinguishable element, feature, color, text, marking, character, shape, or characteristic that differentiates the different boarding status for the seats on the aircraft. For example, first indicia 206 may correspond to blank, white, or unlit seats in seating layout 202, as depicted in FIG. 3. In this embodiment, first indicia 206 is realized as white coloring for seats that are awaiting passenger boarding. In contrast, third indicia 210 may correspond to darkened, shaded, colored, or lit seats in seating layout 202, as depicted in FIG. 3. In this embodiment, third indicia 210 is realized as dark green coloring for seats that have already boarded. Second indicia 208 may correspond to yet another distinguishable shade, pattern, color, or display feature in seating layout 202. It may be desirable to have second indicia 208 conspicuous and easy to detect by passengers in the waiting area. In the embodiment, second indicia 208 is realized as a flashing color for seats that are currently boarding. The flashing color may relatively bright or contrasting with other display features to emphasize the importance of the currently boarding group of seats. In the embodiment, second indicia 208 is realized as a bright green flashing signal for the currently boarding seats. Although not depicted in FIG. 3, seating layout 202 may also utilize additional indicia corresponding to seats that will be boarding next. For example, next-to-board seats may be colored yellow to distinguish them from the other seats on the aircraft. Alternatively, next-to-board seats may be identified by a number that represents the approximate wait time until boarding. For example, one group of seats may have “5” superimposed over the seats to indicate that passengers in those seats will be boarding in about five minutes, another group of seats may have “10” superimposed over the seats to indicate that passengers in those seats will be boarding in about ten minutes, and the like.

The display element for seating layout 202 may also be controlled to display written instructions 212 that change during the boarding procedure. Such written instructions 212 may indicate the rows and/or seats that are currently boarding. The combination of written instructions 212, seating layout 202, and audible notifications is intended to provide sufficient guidance and instruction to passengers in the waiting area.

FIG. 4 is a schematic representation of a system 300 for displaying passenger boarding instructions. System 300 is suitably configured to generate seating layout displays and update the seating layout displays during passenger boarding. System 300 may, for example, produce seating layouts having the general characteristics and features mentioned in the above description of seating layout 202. System 300 generally includes a processing architecture 302, a suitable amount of memory 304, a database 306, an attendant terminal 308, and at least one electronic display element. These components may be coupled together via a suitable data communication bus 309 or any appropriate interconnection arrangement. To illustrate the flexibility and deployment options for system 300, FIG. 4 includes three types of electronic display elements: a passenger gate monitor 310; a passenger terminal monitor 312; and a kiosk monitor 314. System 300 may utilize additional and/or alternative electronic display elements, and these three types are not intended to limit or restrict the application of embodiments of the invention in any way. Furthermore, one or more display elements may be utilized alone or in combination on multiple systems.

Embodiments of the invention may utilize one or more suitably configured software applications that control the generation of the seating layout displays. In practice, the software application(s) may reside at attendant terminal 308, at a mainframe computer system, at a networked server system, or the like. In this regard, processing architecture 302 is generally configured to support the operation and functionality of system 300 as described herein. Processing architecture 302 may be realized as one or more physical or logical components of system 300. In this regard, the various illustrative blocks, modules, and processing logic, described in connection with the embodiments disclosed herein may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

Memory 304 is generally configured to store data or information that may be necessary to support the operation and functionality of system 300 as described herein. Memory 304 may store the software application(s) that control the generation of the seating layout displays described herein. In embodiments, memory 304 can be realized as RAM memory, flash memory, ROM memory, EPROM memory, EEPROM memory, registers, a hard disk, a removable disk, a CD-ROM, or any other form of storage medium known in the art. In this regard, memory 304 can be coupled to processing architecture 302 such that processing architecture can read information from, and write information to, memory 304. In the alternative, memory 304 may be integral to processing architecture 302. As an example, processing architecture 302 and memory 304 may reside in an ASIC.

In this example, processing architecture 302, memory 304, and database 306 are associated with a central computing system or network maintained by an airline. As mentioned above, each aircraft operated by the airline may have a corresponding seating configuration and, therefore, a corresponding electronic seating layout that can be processed by system 300. In this regard, database 306 may contain the electronic seating layouts corresponding to the actual seating configurations for any number of different aircraft. The electronic seating layouts may be stored as separate files, groups of image files, separate applications, or the like. System 300 may utilize conventional database management system technologies to populate, access, and modify the electronic seating layouts maintained in database 306. Briefly, processing architecture 302 is suitably configured to select the appropriate electronic seating layout corresponding to the departing aircraft such that the selected seating layout can be processed and dynamically displayed at one or more of the electronic display elements in the manner described herein.

Passenger gate monitor 310 is located in a passenger gate area 316 of the airport, as described above in the context of FIG. 1 and FIG. 2. Passenger terminal monitor 312 may be located at various locations throughout the airport. For example, passenger terminal monitor 312 may be located near the ticketing counters, in common public areas, near the security clearance areas, in a passenger lounge area, in the baggage claim areas, in the passenger gate area 316, or the like. Passenger terminal monitor 312 may include flight information for multiple aircraft, along with the corresponding seating layouts and current boarding information. Passenger terminal monitor 312 could include a scaled-down version of the seating layout display rendered on passenger gate monitor 310.

Kiosk monitor 314 may be located at various locations throughout the airport. For example, kiosk monitor 314 may be located near the ticketing counters, in common public areas, near the security clearance areas, in the baggage claim areas, in the passenger gate area 316, or the like. Kiosk monitor 314 may include flight information, the corresponding aircraft seating layout, and current boarding information for a flight under observation. Kiosk monitor 314 could include a scaled-down version of the seating layout display rendered on passenger gate monitor 3 10.

Attendant terminal 308 represents a computing device or system that might be located in passenger gate area 316. In practice, attendant terminal 308 may be located at the airline flight crew counter or at the entrance to the passenger gate. In embodiments, the existing boarding computer would suffice if it is networked to the electronic display elements. Attendant terminal 308 is suitably configured to run the appropriate application software to initiate the generation and display of the seating layouts. Moreover, attendant terminal 308 may be configured to control updating of the dynamic characteristics of the seating layouts.

In one embodiment, an electronic display element may be manually controlled via a user interface at attendant terminal 308 to update and display the current seating layout in response to a desired boarding sequence for the aircraft. Such manual control may be initiated at attendant terminal 308 by a crew member. The desired boarding sequence may follow a particular boarding strategy that is programmed into system 300, however, the crew member may still have manual control over the dynamic display characteristics of the seating layout. The data for the departing aircraft may, for example, have default seat groupings corresponding to a default boarding sequence. The default settings could be utilized to simplify user interaction with system 300. For example, after first class seating has completely boarded, the crew member may select a “Next” graphical icon or engage the “Enter” keyboard button at attendant terminal 308 to proceed to the next seating group. In response to this user interaction, the appropriate seating layout displays are updated to reflect the new boarding status (e.g., a certain section of coach class seats may be displayed with the “currently boarding” indicia while the first class seats may be displayed with the “boarded” indicia). In practice, more than one boarding status indicia can be displayed simultaneously.

System 300 may be designed to allow the user to override the default settings (or system 300 may be configured with full manual control in lieu of default settings). Full manual control may be desirable to enable crew members to have complete control over the boarding sequence. In this regard, system 300 may be configured to allow the user to select individual seats, seat rows, or any combination of seats via a user interface at attendant terminal 308. For example, attendant terminal 308 may display an interactive seating layout having selectable seat features that can be highlighted using a mouse or any pointing device. After selecting a number of seats to be boarded, the user can select a “Next” graphical icon or engage the “Enter” key at attendant terminal 308 to initiate boarding of the selected group of seats. In response to this user interaction, the appropriate seating layout displays are updated as described above. Such manual operation allows the crew members to optimize the boarding procedure in accordance with the actual real-time passenger count and passenger flow.

In another embodiment of system 300, the electronic display element may be automatically controlled to update and display the current seating layout in response to a programmed boarding sequence for the aircraft. The programmed boarding sequence may represent a desired boarding strategy having predetermined boarding time periods for different sections of the aircraft. In practice, database 306 may contain any number of programmed boarding sequences corresponding to different aircraft operated by the airline, and the specific programmed boarding sequence may be selected or initiated via manipulation of attendant terminal 308. Use of a programmed boarding sequence, automatic updating of the seating layout, and automated updating of the boarding instructions may be desirable in certain situations to free up crew members at the passenger gate area.

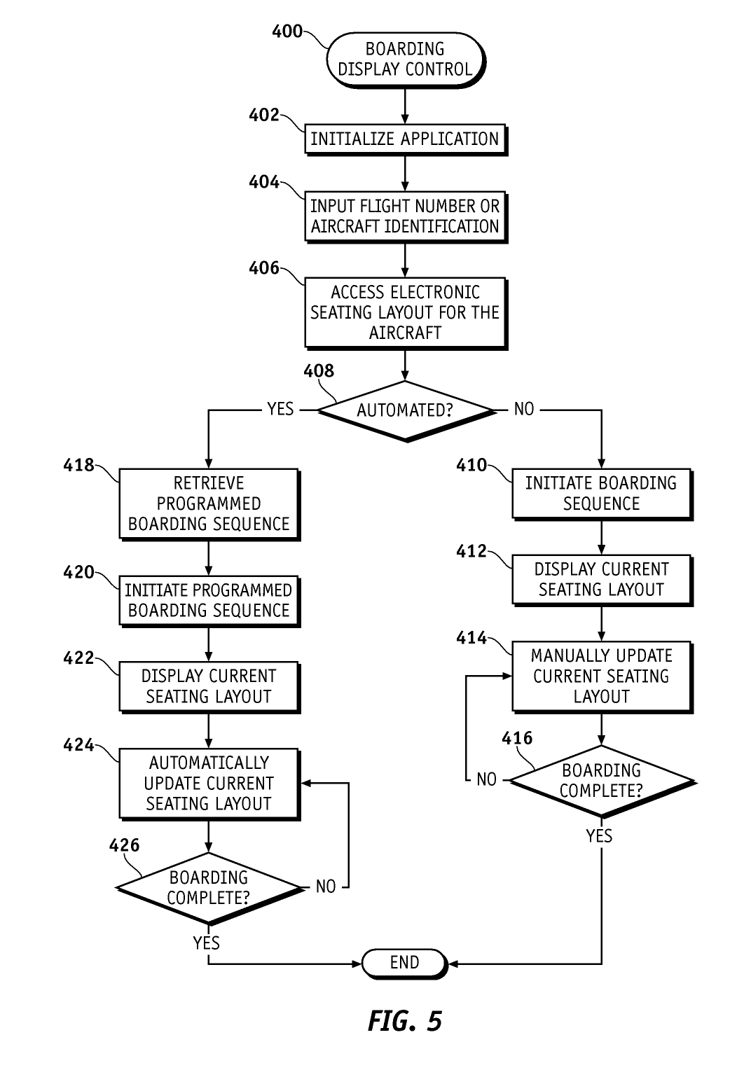

FIG. 5 is a flow chart of an example boarding display control process 400 that may be performed to provide boarding instructions to passengers. The various tasks performed in connection with process 400 may be performed by software, hardware, firmware, or any combination thereof. For illustrative purposes, the following description of process 400 may refer to elements mentioned above in connection with FIGS. 1-4. In embodiments of the invention, portions of process 400 may be performed by different elements of the described system, e.g., processing architecture 302, attendant terminal 308, or one or more electronic display elements. It should be appreciated that process 400 may include any number of additional or alternative tasks, the tasks shown in FIG. 5 need not be performed in the illustrated order, and process 400 may be incorporated into a more comprehensive procedure or process having additional functionality not described in detail herein.

Boarding display control process 400 assumes that a suitable system has already been configured and initialized with appropriate application software and the necessary electronic seating layout templates for the departing aircraft. Process 400 may begin by initializing the software application (task 402). Process 400 may then receive as inputs: the flight number, aircraft identification, or other data that identifies the departing aircraft (task 404). This information may, for example, be entered at an attendant terminal or other passenger gate computing device. This information can be used to access a particular electronic seating layout corresponding to the actual seating configuration for the departing aircraft (task 406). As mentioned above, the electronic seating layout may be maintained in a suitably configured database, and it may be accessed for processing and rendering as a display.

Boarding display control process 400 may be designed to support automated or manual display updating. If process 400 is not automated (query task 408), then a task 410 may be performed to initiate a boarding sequence corresponding to the departing aircraft. As mentioned above, the layouts or seating configuration of the different aircraft models would be pre-loaded into a database. The typical or desired boarding sequence for each aircraft model would also be pre-loaded into the database. When boarding, the ground crew can activate the appropriate aircraft model for the seating layout display. Once the boarding sequence is initiated, process 400 proceeds to display the current seating layout on one or more electronic display elements (task 412). Initially, the seating layout might indicate that all seats are awaiting boarding. Once boarding actually begins, however, the ground crew can access the boarding program and proceed through the desired boarding sequence (e.g., selecting “next” from a graphical user interface). Such user interaction enables process 400 to obtain real-time passenger boarding information for the departing aircraft. This user interaction represents manual updating of the current seating layout (task 414 in response to the boarding sequence. In practice, the current seating layout will be displayed on the passenger display element(s) with one or more distinguishing indicia that differentiates the boarding status for the seats on the aircraft. These features and characteristics were described above in connection with FIG. 3.

If boarding is complete (query task 416), then boarding display control process 400 can end. At this point, the current seating layout display may indicate that all of the seats have already boarded. If, however, boarding is incomplete, then process 400 may be re-entered at task 414 to obtain updated boarding information and to facilitate updating of the current seating layout display as the boarding sequence proceeds.

Referring again to query task 408, if boarding display control process 400 is automated, then a task 418 may be performed to retrieve the programmed boarding sequence for the departing aircraft. In practical embodiments, a crew member may initiate the programmed boarding sequence (task 420). Once the programmed boarding sequence is initiated, process 400 proceeds to display the current seating layout on one or more electronic display elements (task 422). The initial seating layout might indicate that all seats are awaiting boarding. Alternatively, the programmed boarding sequence may be initiated in conjunction with the boarding of the first group of seats. Once boarding actually begins, process 400 can automatically provide real-time passenger boarding information for the departing aircraft, and automatically update the current seating layout (task 424) in response to the programmed boarding sequence. In practice, the current seating layout will be displayed on the passenger display element(s) with one or more distinguishing indicia that differentiates the boarding status for the seats on the aircraft. These features and characteristics were described above in connection with FIG. 3.

If boarding is complete (query task 426), then boarding display control process 400 can end. At this point, the current seating layout display may indicate that all of the seats have already boarded. If, however, boarding is incomplete, then process 400 may be re-entered at task 424 to continue obtaining updated boarding information and to facilitate automatic updating of the current seating layout display until the boarding sequence ends.

In summary, the system and technique described herein can be deployed in an airport environment to provide a visual display of aircraft boarding instructions to waiting passengers. The visual display supplements the traditional audible call-offs and enhances the efficiency and effectiveness of the boarding strategy.

While at least one embodiment has been presented in the foregoing detailed description, it should be appreciated that a vast number of variations exist. It should also be appreciated that the embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention, where the scope of the invention is defined by the claims, which includes known equivalents and foreseeable equivalents at the time of filing this patent application.

What is claimed is:

1. A passenger boarding display comprising an electronic display element controlled to display a seating layout for a vehicle, the seating layout having dynamic characteristics that are representative of real-time passenger boarding information.

2. A passenger boarding display according to claim 1, the display element comprising a passenger gate monitor.

3. A passenger boarding display according to claim 1, the display element comprising a passenger terminal monitor.

4. A passenger boarding display according to claim 1, the seating layout having predetermined characteristics that are representative of an actual seating configuration for the vehicle.

5. A passenger boarding display according to claim 4, the predetermined characteristics of the seating layout comprising a view of seats on the vehicle.

6. A passenger boarding display according to claim 4, the predetermined characteristics of the seating layout comprising seat position identifiers for seats on the vehicle.

7. A passenger boarding display according to claim 4, the predetermined characteristics of the seating layout comprising row designations for seats on the vehicle.

8. A passenger boarding display according to claim 4, the predetermined characteristics of the seating layout comprising class designations for seats on the vehicle.

9. A passenger boarding display according to claim 1, the dynamic characteristics of the seating layout comprising indicia corresponding to seats on the vehicle that are awaiting passenger boarding.

10. A passenger boarding display according to claim 1, the dynamic characteristics of the seating layout comprising indicia corresponding to seats on the vehicle for which passengers are currently boarding.

11. A passenger boarding display according to claim 1, the dynamic characteristics of the seating layout comprising indicia corresponding to seats on the vehicle that have already been boarded by passengers.

12. A passenger boarding display according to claim 1, the electronic display element being automatically controlled to update and display a current seating layout in response to a programmed boarding sequence for the vehicle.

13. A passenger boarding display according to claim 1, the electronic display element being manually controlled to update and display a current seating layout in response to a boarding sequence for the vehicle.

14. A method of displaying passenger boarding instructions for a vehicle, the method comprising:
accessing an electronic seating layout corresponding to an actual seating configuration for the vehicle;
obtaining real-time passenger boarding information for the vehicle; and
displaying a current seating layout on a passenger display element, the current seating layout having predetermined characteristics that are representative of the actual seating configuration for the vehicle, and the current seating layout having dynamic characteristics that are representative of the real-time passenger boarding information.

15. A method according to claim 14, wherein displaying the current seating layout comprises:
displaying first indicia for seats on the vehicle that are awaiting passenger boarding;
displaying second indicia for seats on the vehicle for which passengers are currently boarding; and
displaying third indicia for seats on the vehicle that have already been boarded by passengers.

16. A method according to claim 14, further comprising automatically updating the current seating layout in response to a programmed boarding sequence for the vehicle.

17. A method according to claim 14, further comprising manually updating the current seating layout in response to a boarding sequence for the vehicle.

18. A system for displaying passenger boarding instructions for a vehicle, the system comprising:
a database containing electronic seating layouts corresponding to actual seating configurations for a number of different vehicles;
a processing architecture coupled to the database, the processing architecture being configured to select an electronic seating layout for a designated vehicle; and
an electronic display element coupled to the processing architecture, the electronic display element being configured to display a current seating layout for the designated vehicle, the current seating layout having predetermined characteristics that are representative of an actual seating configuration for the vehicle, and the current seating layout having dynamic characteristics that are representative of real-time passenger boarding information.

19. A system according to claim 18, further comprising an attendant terminal coupled to the electronic display element, the attendant terminal being configured to control updating of the dynamic characteristics.

20. A system according to claim 18, the electronic display element being controlled to display:
first indicia for seats on the vehicle that are awaiting passenger boarding;
second indicia for seats on the vehicle for which passengers are currently boarding; and
third indicia for seats on the vehicle that have already been boarded by passengers.

21. A system according to claim 18, wherein:
the database contains a programmed boarding sequence for the designated vehicle; and
the electronic display element is controlled to update the dynamic characteristics in response to the programmed boarding sequence.

22. A system according to claim 18, wherein:
the database contains electronic seating layouts corresponding to actual seating configurations for a number of different passenger aircraft;
the designated vehicle is a passenger aircraft; and
the electronic display element comprises a passenger gate monitor.

23. A system according to claim 22, further comprising a passenger terminal monitor coupled to the processing architecture, the passenger terminal monitor being configured to display the current seating layout.
